(19) United States
(12) Patent Application Publication
(10) Pub. No.: US 2014/0122110 A1
(43) Pub. Date: May 1, 2014

(54) SYSTEM AND METHOD FOR PROBLEM-ORIENTED PATIENT-CONTEXTUALIZED MEDICAL SEARCH AND CLINICAL DECISION SUPPORT TO IMPROVE DIAGNOSTIC, MANAGEMENT, AND THERAPEUTIC DECISIONS

(71) Applicant: Logical Images, Inc., Rochester, NY (US)

(72) Inventors: Arthur Papier, Rochester, NY (US); Noah Craft, Venice, CA (US)

(73) Assignee: Logical Images, Inc., Rochester, NY (US)

(21) Appl. No.: 14/067,133

(22) Filed: Oct. 30, 2013

Related U.S. Application Data
(63) Continuation-in-part of application No. 14/010,695, filed on Aug. 27, 2013.
Application No. 14/010,695 is a continuation of application No. 09/919,275, filed on Jul. 31, 2001, now Pat. No. 8,538,770.
(60) Provisional application No. 61/720,034, filed on Oct. 30, 2012.
(60) Provisional application No. 60/222,573, filed on Aug. 1, 2000.
(60) Provisional application No. 60/275,282, filed on Mar. 13, 2001.
(60) Provisional application No. 60/307,919, filed on Jul. 26, 2001.

(51) Int. Cl. G06F 19/00

(52) U.S. Cl. CPC G06F 19/345
USPC 705/2

(57) ABSTRACT

Disclosed is a system and method to transform a complex diagnostic and management decision-making process found in western medicine into a novel and unique medical tool comprising a novel diagnostic decision support system and therapeutic optimization. The technologies result in more accurate diagnoses and more effective and appropriate therapeutic plans for individual patients.

This application claims priority, under 35 U.S.C. §119(e), from U.S. Provisional Patent Application No. 61/720,034, filed on Oct. 30, 2012 by A. Papier and N. Craft, and the Provisional Application is also hereby incorporated by reference in its entirety. This application also claims priority from each of the following applications, co-pending U.S. patent application Ser. No. 14/010,695, for a SYSTEM AND METHOD TO AID DIAGNOSES USING CROSS-REFERENCED KNOWLEDGE AND IMAGE DATABASES, by A. Papier et al., filed Aug. 27, 2013, which is a continuation of U.S. patent application Ser. No. 09/919,275, for a SYSTEM AND METHOD TO AID DIAGNOSES USING CROSS-REFERENCED KNOWLEDGE AND IMAGE DATABASES, by A. Papier et al., filed Jul. 31, 2001 (now U.S. Pat. No. 8,538,770, issued Sep. 17, 2013), and from Provisional Application No. 60/275,282 for a “SYSTEM AND METHOD TO AID DIAGNOSES USING CROSS-REFERENCED KNOWLEDGE AND IMAGE DATABASES,” N. Weyl, filed Mar. 13, 2001; Provisional Application No. 60/222,573 for a “SYSTEM AND METHOD FOR CROSS-REFERENCED KNOWLEDGE AND IMAGE DATABASES TO REDUCE DIAGNOSTIC UNCERTAINTY,” by A. Papier, filed Aug. 1, 2000; Provisional Application No. 60/307,919 for a “PILL IDENTIFICATION PERIPHERAL,” by J. Weyl, filed Jul. 26, 2001, all of the above being hereby incorporated by reference in their entirety.

The systems and methods disclosed herein are directed to medical search and decision support to generate more accurate and more relevant differential diagnoses at the point of care. One method is based on a core principle of reducing all diagnostic concepts and all medical thought to problem-oriented core principle findings and choosing only the relevant core findings for the patient at hand before beginning a process of a differential diagnosis search. The results are then contextualized to the specific patient after the search is performed. This problem-oriented and patient-contextualized (POPC) approach is fundamentally different than known prior approaches. This core principle is fundamental to improving the practice of medicine. In the embodiments described the approach will lead to more accurate diagnosis, better management, and better treatment for the individual patients. Importantly, restructuring the diagnostic (Dx)—problem—knowledge relational database structure can lead to vastly improved public health surveillance and rapid improvements in the overall practice of medicine when applied systematically and systemically to large populations. When incorporated into the electronic medical record (EMR), the systems and methods described here will allow for greatly improved individual patient care while simultaneously re-structuring the data in the EMR to allow for more powerful, more accurate, and previously impossible research across populations.

### BACKGROUND AND SUMMARY

Prior efforts to develop computer assisted diagnosis have spanned 50 years and many diagnostic systems have been developed, yet few physicians use a computer to assist diagnosis as they evaluate their patients. No such prior technology approaches have led to widespread physician adoption of computer assisted diagnosis. Prior efforts were not in the physician workflow and were time-consuming to utilize. Most did not lead to a useful differential diagnosis. The transition to electronic medical records (EMRs) presents a new opportunity to bring computer-assisted diagnosis to the practicing physician. EMRs contain many of the data elements critical to differential diagnosis and are consistently organized around a patient problem list. The problem list is described as a key opportunity as a location and workflow moment to offer clinicians diagnostic support. The embodiments disclosed herein present a novel strategy to promote computer-assisted diagnosis in a manner consistent with current physician mindset and workflow that can originate in and interface with the EMR.

Autopsy studies and other research suggest an overall diagnostic error rate of at least 20-30% in medicine. Most of these errors are due to cognitive mistakes on the part of the individual practitioner. Premature closure, overconfidence, anchoring and a host of other cognitive mistakes play a role in diagnostic error. While prior and current efforts in diagnostic support have required entry of patient symptoms and signs and other patient features, the disclosed system includes a computer-based systems and methods allowing the physician to begin with either a problem, a presumed diagnosis, a drug, a symptom, or a constellation of any of the above.

Historically in medicine, differential diagnosis (DDx) lists were based around “single concept” orientation. Examples include DDx lists based on specific Dxs (i.e. what is the DDx for pancreatitis?), based on specific solitary symptoms (i.e. what is the DDx for a solitary red papule?) or common problems (what is the DDx for chest pain?), or based on body location (i.e. what is the DDx for a rash on the hand?), or based on confounding medical histories (i.e. what problems are common in pregnant women?) Books have been published including lengthy lists of such DDxs, but there is little agreement between or standardization of these lists. Additionally, in the past two decades, prior attempts at computerized diagnostic decision support have been made. Efforts include products such as Isabel, Diagnosaurus, DxPlain, Pepid, Google, BMJ, and VisualDx as well as other attempts to create a system to generate a DDx list based on a specific Dx or based on a specific symptom. Some systems, such as VisualDx, allow the user to enter multiple symptoms or findings. The mechanisms underpinning these systems vary, but typically they rely on either web crawling and text proximity relationships, compilations of standard lists as mentioned above, simple neural networking relationships, tree-structured search, etc. None of these tools except VisualDx and Google are in widespread use by physicians in a routine way. The current problem is compounded by the fact that many EMRs depend so heavily on the problem list, that they demand clinicians to make a Dx before any functionality of the EMR or search is available. This very fact preempts a natural time to consider a DDx in the normal workflow.

The disclosed systems and methods present a model that begins at the point where most errors in diagnosis are made—that is post diagnosis. Starting from a point where specific diagnoses or problems have been given to a patient (i.e. the problem list in the EMR), we have devised a way to use specific structured knowledge relationships to define the principle components of Dxs that can then be used to generate a much more accurate and impactful DDx that is relevant to the current patient and situation. Considering an example employing existing technologies, one might have a patient with a presumed diagnosis of sarcoidosis and be faced with the question, “what is the DDx of sarcoidosis?” The results would be a long list of DDxs that includes diseases that manifest with skin rashes, pulmonary symptoms, eye problems, etc.—with no structure or predictable relevance to the current patient. Another example in the case of a new patient presenting with a cough and the clinician may want to search “what is the DDx of cough?” The results would be so overwhelming as to not be helpful. No prior examples of medical search allow for meaningful DDx decision support from the problem list or from the EMR in general.

The systems and methods include a novel process to improve diagnostic accuracy based on complexity reduction through a structured knowledge relationship database. Although the “textbook” definition of many diseases (diagnoses) and the associated symptoms and findings are well described in the medical literature and textbooks, the process of making a diagnosis is not well defined. Traditionally, physicians combine and compile symptoms, medical history, and findings, etc. into diagnostic categories which are complex and somewhat haphazard constellations of symptoms called a “diagnosis” (Dx). This process is severely flawed and hinges on wide variations in physician knowledge, biases, and incomplete medical records. To compound this process, it is very rare for any individual patient to manifest the “textbook” definition of a Dx or to have each and every symptom or finding associated with a specific Dx. Despite this, all medical thought is organized around the management and treatment of specific Dxs. Indeed, the electronic medical record (EMR) itself is organized around problem lists that contain primarily specific Dxs. At any moment in the care of the patient, the EMR contains no knowledge of the accuracy of an assigned Dx or the particular problems or symptoms a patient is suffering from that may be a component of the Dx. There is no way to relate any of the Dxs in the EMR to other parts of the EMR in an organized fashion that will assist in correcting Dx accuracy or allow for customized care of the patient based on the data in the EMR. There is no way to assess or study these problems nationally and across EMRs.

The disclosed systems and methods reduce individual Dxs into their core components and use these core components in the context of real patients' symptoms to build more accurate DDx lists. We refer to these core components in this application as Principle Findules (PFs) that represent the most fundamental categories of clinical symptoms of disease presentation. PFs may include more granular subsets of symptoms or data called findings. For example, the PF “abdominal pain” may include subtypes of abdominal pain like “right upper quadrant abdominal pain” and “left upper quadrant abdominal pain”. The core components or PFs, Dxs, and findings will be kept in a highly structured knowledge management database. The computerized search associated with these novel systems and methods can begin either in the EMR problem list, the medication list, or with traditional physician thought processes such as a suspected diagnosis or symptoms. The results of this novel PF-based approach to DDx can be described as a “Problem-Oriented, Patient-Contextualized DDx” or POPC-DDx and will lead to profoundly more accurate, useful, and relevant decision support for the clinician and patient. This approach will also power other embodiments of the systems and methods including disease management, work ups of symptoms, and treatment of patients. Additionally, the system could also automatically detect underlying diseases or causative drugs that are responsible for any of the presumptive Dxs, perceived problems, or symptoms. Following this novel method, a clinician or the patient himself or herself could query the accuracy of any given Dx based on the PFs, structured knowledge, and DDx associated with any constellation of problems or symptoms they may or may not have. The systems and methods are so profound and fundamental that when combined with the known medical literature and the expert knowledge built into the knowledge management database, it may result in more appropriate work-ups or management plans, as well as more accurate and effective treatment plans, and more patient-relevant health education. The reduction of Dxs to PFs before beginning any additional analysis of the patient or data in the EMR will remove the inherent diagnostic error in the existing EMR problem list and classifications of disease. This novel structure of knowledge-Dx relationships also allows for embodiments of these systems and methods to markedly improve public health surveillance of diseases and automated EMR health diagnostic assessments. Implementation of these processes may lead to decreased medical liability risk for misdiagnosis.

Disclosed in embodiments herein is a method, operating in accordance with a program on a computer, to improve medical diagnostic accuracy, comprising: using the computer, reducing a medical search to a plurality of fundamental problems called Principle Findules (PFs), and compiling at least one associated database with data for the PFs; and building differential diagnoses (DDx) from PFs based upon patient information (e.g., EMR, observations, testing, etc.).

Further disclosed in embodiments herein is a system to improve medical diagnostic accuracy, comprising: using a computer operating in accordance with a program stored on computer readable media, to reduce a medical search to a plurality of fundamental problems called Principle Findules (PFs); in response to a user input, said computer compiling at least one associated database with data for the PFs, said database stored in a computer readable media; and building differential diagnoses (DDx) from PFs based upon patient information (e.g., EMR, observations, testing, etc.).

### BRIEF DESCRIPTION OF THE DRAWINGS

FIG. 1A is an exemplary computer-based system for carrying out one or more aspects of the disclosed embodiments;

FIG. 1B is a representative flow diagram of a reduction of diagnoses (Dxs) to Principle Findules (PFs) and further reduction of Principle Findules to diagnostic management categories in accordance with a disclosed embodiment;

FIGS. 2A-2B illustrate a logistical workflow of a system disclosed herein and the internal components associated with such a system;

FIGS. 3A-3C are illustrative examples of a problem oriented, patient contextualized (POPC) medical search using a presumptive diagnosis of pancreatitis in an adult male patient with abdominal pain and vomiting, where FIG. 3A illustrates a traditional differential diagnosis, FIG. 3B illustrates a problem orientation to reduce complexity, and FIG. 3C represents patient contextualization to improve relevance; and

FIGS. 4-15 are further exemplary flow diagrams illustrating operations carried out by an embodiment(s) of the disclosed system in accordance with several examples set forth herein.

The various embodiments described herein are not intended to limit the disclosure to those embodiments described. On the contrary, the intent is to cover all alternatives, modifications, and equivalents as may be included within the spirit and scope of the various embodiments and equivalents set forth. For a general understanding, reference is made to the drawings. In the drawings, like references have been used throughout to designate identical or similar elements. It is also noted that the drawings may not have been drawn to scale and that certain regions may have been purposely drawn disproportionately so that the features and aspects could be properly depicted.

### DETAILED DESCRIPTION

For the purposes of this application and simplicity, the following names of components are described and used herein. The entire process and at least one embodiment of these systems and methods will be called Medweaver. Individual components are named AccuDx, AccuMx, AccuTx to connote a technology that results in more accurate diagnoses (Dx), best choices for management (Mx), and more effective and appropriate treatments (Tx) for any given problem(s) in any given patient. An existing system, VisualDx, which is at least partially disclosed in U.S. Pat. No. 8,538,770, hereby incorporated by reference in its entirety, is a visually-based component for DDx building, and a user interface that may be further refined and incorporated into the Medweaver system as well. Another component is a patient-facing interface and feedback system called Healthweaver. Yet another component is an interface with patient-specific or population specific metagenetic data (genomics, transcriptomics, microbiomoics, etc.) called Geneweaver. A further component, called the Untangler, is an automated EMR analytical tool that searches the EMR problem list, progress notes, lab data, and medication lists for a particular patient or case (e.g., may include EMRs from a family or group or individuals that are related in circumstances such as exposures, etc.) to look for underlying causative Dxs or medications that could better explain any individual or groups of problems or symptoms.

Although other professional and scientific industries have developed technologies to codify and simplify problem-solving processes, the medical profession has failed to do so in a meaningful way. In the disclosed systems and methods, we describe a process and technology to transform complex diagnostic and management decision-making processes of western medicine into a new and unique medical search method including a novel diagnostic decision support system, management process, and therapeutic optimization procedure. The disclosed system and method will result in more accurate diagnoses, efficient case management and work-up options, and more effective and appropriate therapeutic plans for individual patients.

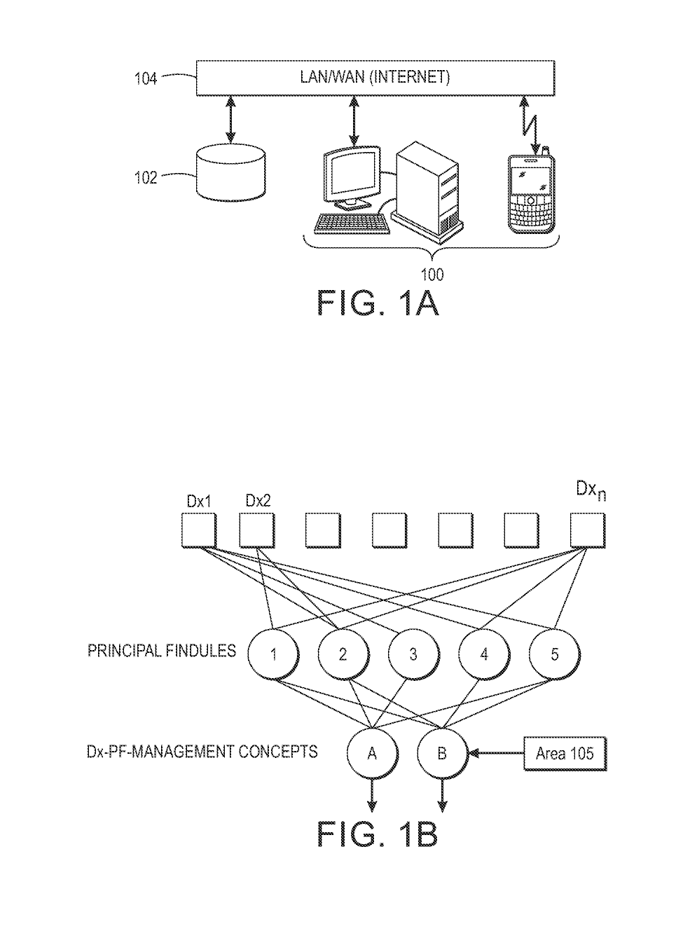

For the purposes of this application, the entire process and embodiment of these systems and methods will be called Medweaver and individual components are named AccuDx, AccuMx, AccuTx. Notably, the existing system, VisualDx (as at least partially disclosed in U.S. Pat. No. 8,538,770; and Provisional Application 06/222,573, filed Aug. 1, 2000), will be refined and incorporated into the Medweaver system as well. Referring to FIG. 1, in one embodiment Medweaver includes a method, operating in accordance with a program on a computer of similar system 100 that includes a processor of CPU along with memory (e.g., RAM) for storing programmable instructions in the nature of executable software, apps, etc. Although described as a memory associated with the computer, the program may be stored on any computer readable media. The method to improve medical diagnostic accuracy, uses the computer, and reduces a medical search to a plurality of fundamental problems called Principle Findules (PFs), and compiling at least one associated database 102 with data for the PFs. The database may be stored locally on the computer or may otherwise be accessible via a network 104. The computer also builds differential diagnoses (DDx) from PFs based upon patient information (e.g., EMR, observations, testing, etc.) which may be stored in the database, or may otherwise be accessible via the network. Although depicted using conventional computing platforms (e.g., workstation and smart-phone), it will be appreciated that the disclosed systems and methods are not limited to the particular hardware disclosed. Moreover, the embodiments are specifically contemplated to include equipment conventionally found in medical environments, and are not limited to those disclosed. Furthermore, the embodiments also include conventional user-interface techniques such as keyboards and displays as illustrated in FIG. 1, but may also include a number of other well-known techniques. For example, the display may be a touchscreen, suitable for the display of information and the receipt of user input. In another embodiment, the display may include a Google Glass or similar eyewear embedded display to enable a medical professional to easily access and view information while interacting with a patient.

All of these systems and methods are premised upon each patient and each presentation of disease being exceedingly complex and completely unique. A central problem at hand is that it is not possible to assess and remember the complexity of the individual patient medical data. Additionally, it is not possible to know the entirety of relevant medical literature at any given time. An analogy is that each patient is a highly complex and unique tapestry comprised of an infinite number of threads of varying colors and lengths that is perceived as a whole. It is impossible to see and understand the entire tapestry from afar while appreciating every individual thread of the tapestry at the same moment. The Medweaver systems and methods and its various sub-components are designed to help determine the value and importance of each of the threads of the tapestry. In medical terms, Medweaver will help determine the relevance and importance of symptoms or problems a patient may exhibit and help the clinician arrive at the most accurate diagnosis and treatment plan. One can search by an individual symptom, or by a presumptive diagnosis based on the physician's assessment of the patient's constellation of symptoms and medical history. Medweaver will reduce the complexity of the query into core or principle components that are common across all relevant patient-disease-finding relationships and return results that are contextualized for the specific patient or situation at hand.

To address this central problem, the core of the Medweaver method is based on the use a specific process to reduce the complexity of the known set of medical diagnoses (Dx), symptoms (Sx), lab results (Lx), or drugs (Rx) into novel units called Principle Findules (PFs). These PFs can be derived from specific areas in the EMR or from the user search approach based upon observation and/or other data. For example, in the EMR, a user could click on any diagnosis in the problem list and Medweaver will prompt the user to enter the relevant PFs that the patient is suffering from that are associated with this diagnosis. These PFs can then be contextualized to the unique patient being evaluated based on individual characteristics of the patient and the presentation. In one component of the Medweaver process called AccuDx, this set of patient contextualized PFs can be leveraged using a rigorously structured knowledge management database to dynamically create accurate differential diagnoses (DDx) immediately at the point of care. The AccuDx results can be further refined with a more detailed search or more granular symptoms, labs, or medical history data. Overlaying this detailed search onto the initial AccuDx-generated DDx results based on patient-specific PFs would result in an even more refined DDx.

In the component called AccuMx, the PFs can be leveraged to arrive at the most efficient and effective management plan (Mx) or required work-up to confirm a diagnosis. The resulting DDx or Mx thus represents a true problem-oriented and patient contextualized (POPC) DDx or Mx for a given diagnosis and specific set of symptoms. A third component of Medweaver, AccuTx further leverages the PF-based results of AccuDx to provide the most appropriate and effective treatment (Tx) contextualized to a given patient with a particular presentation of disease, co-morbidities, and personal values. Together, the AccuDx, AccuMx, and AccuTx systems and methods in their full embodiments, provide search functionality to the EMR and will transform the process of medical diagnostic and therapeutic decision-making as we know it today.

Also contemplated is the ability to use “reach-back” and “feed-forward” approaches relating to data from the electronic medical record and to potential user interfaces for patients to improve diagnosis and treatment for the given individuals and for the system as a whole. These systems and methods will initially be based upon existing medical literature and medical expertise as codified by experts into a highly structured knowledge management system that accounts for these unique relationships between individual components as described further below. Subsequent embodiments of the Medweaver systems and methods, however, are contemplated to include additional power and refinements through the processing of medical error case analysis and through feedback loops using electronic medical records, patient outcomes, as well as patient self-reporting. Additionally, another embodiment would include an interface that will allow the use of expert contributors or “wiki-like” groups where clinical experts input their knowledge and experience into a wiki-like forum. This knowledge would then be similarly “codified” and incorporated into the structured knowledge database in a dynamic and real-time manner.

The Medweaver systems and methods, including its sub-components AccuDx, AccuMx, and AccuTx hinge on multiple new approaches to the design of medical decision support. The central concept is to reduce the complexity of all medical thought to novel units called PFs in a structured knowledge database and then to power an analytical processing engine using novel structured data relationships as defined herein. Examples of the novel data relationships include “Citation-PF-DDx-Dx-Context-Outcome,” “Outcome-PF-Dx-Context,” “Medical Error Case-PF-Dx-Context,” and “Medical Error Case-Dx-PF-Tx-Context”. Additional research in one embodiment would center on methodically studying medical errors and extracting data through relationships such as “Medical Error case-PF-Wrong Dx-Correct Dx-Context” or “Medical Error case-Dx-PF-Wrong Tx-Correct Tx-Context”. Another embodiment would include the ability to structure novel knowledge finding relationships based on individual case compilations in real time. Examples of these relationships include “Case-Dx-PF-Context-geography” and “Case-Dx-PF-Context-effective therapy”. An additional embodiment would leverage the PF-based Medweaver approach to power a similar AccuMx module focusing primarily on choosing appropriate and justifiable tests/labs/scans to rule in or rule out an individual Dx in a DDx generated through the AccuDx program.

An additional embodiment, for example the “Untangler”, would automatically “reach back” into the EMR to detect all diagnoses, problems, and medications for an individual patient. All diagnoses and problems would simultaneously be reduced to PFs through Medweaver analysis and then the Untangler would determine the likelihood that multiple diagnoses or problems were being caused by one of the medications the patient is taking. The same Untangler process could be used to determine if multiple PFs or Dxs could be unified by one underlying and causative Dx that was previously not considered or dismissed.

An additional embodiment would leverage the Medweaver approach to medical decision making to power a patient-centered interface where patients would be able to learn about their own diseases and engage in decision making or help improve their own diagnosis and treatment plans. Complex medical information and Dxs would be reduced to PFs and presented to patients in a manner that is relevant to their exact problems and context. This patient-facing interface may be called Healthweaver. An additional embodiment of a patient facing interface could incorporate certain patient values or lifestyle choices to improve the AccuDx DDx, the AccuMx approach, or the AccuTx treatment plan based on these values. For example, it may be known that a patient does not believe in blood transfusions for religious reasons. This feature in Healthweaver could influence the therapeutic options presented in the AccuTx method or the fact that a patient is a regular user of recreational intravenous drugs may influence laboratory test considerations in the AccuMx planning or diagnostic considerations in the context of AccuDx.

An additional embodiment connecting Medweaver and Healthweaver would include a patient contextualization feature or “reach-back” approach called Geneweaver that may include individual patient genetic sequence data or epidemiological data about a patient based on high-throughput genetic sequencing of many metadata types (including but not limited to genomics, transcriptomics, microbiomics, proteomics, phenomics, and metabolomics, collectively known as “omics”) as well as detailed relationships to personal and family medical histories or to the associated “omics” in any of those relationships.

In another embodiment, Geneweaver could generate its own set of novel PFs and could be used as a stand-alone searching element into the Medweaver structured knowledge database. For example, as our understanding of genomics, microbiomics, transcriptomics, etc. grows, this system and method would allow a reduction of the complexity of the data to core PFs represented by genetic data. This represents a form of granular contextualization that will only grow more and more important as this database grows and becomes more universally available.

An additional embodiment would include methods to facilitate and improve health services outcomes research and drug effectiveness research using the PF-powered structured knowledge database of Medweaver to improve the statistical power and sensitivity of effectiveness detection during drug trials or during Phase 4 clinical trials or when medications are already in widespread use.

An additional embodiment would use the PF-powered structured knowledge database in the Medweaver system to guide and update public health alerts and surveillance. These public health processes will in turn help power and improve the Medweaver programs in real time.

Having described the general features of the disclosed system and methods, attention is now turner to several illustrative, yet non-limiting, examples.

### EXAMPLES

1) Search Dx from the EMR problem list—Pancreatitis:

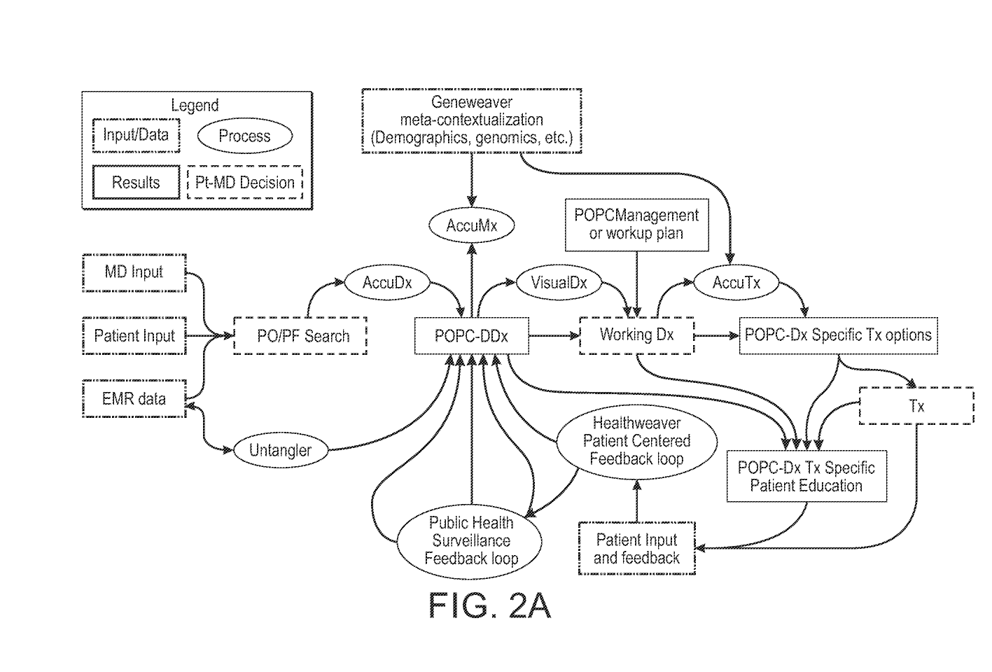

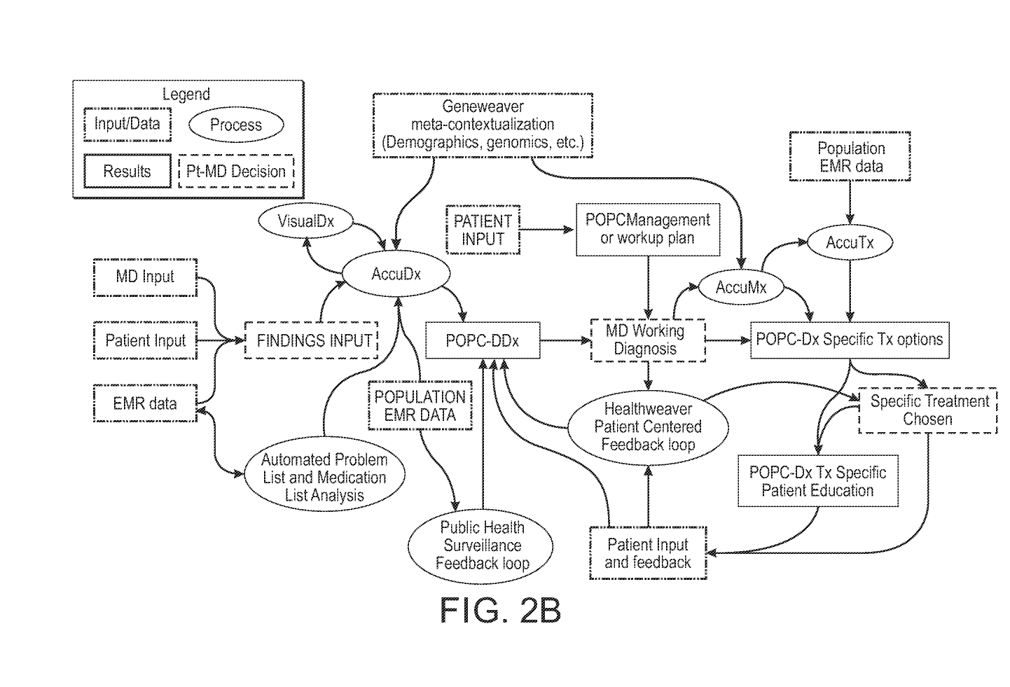

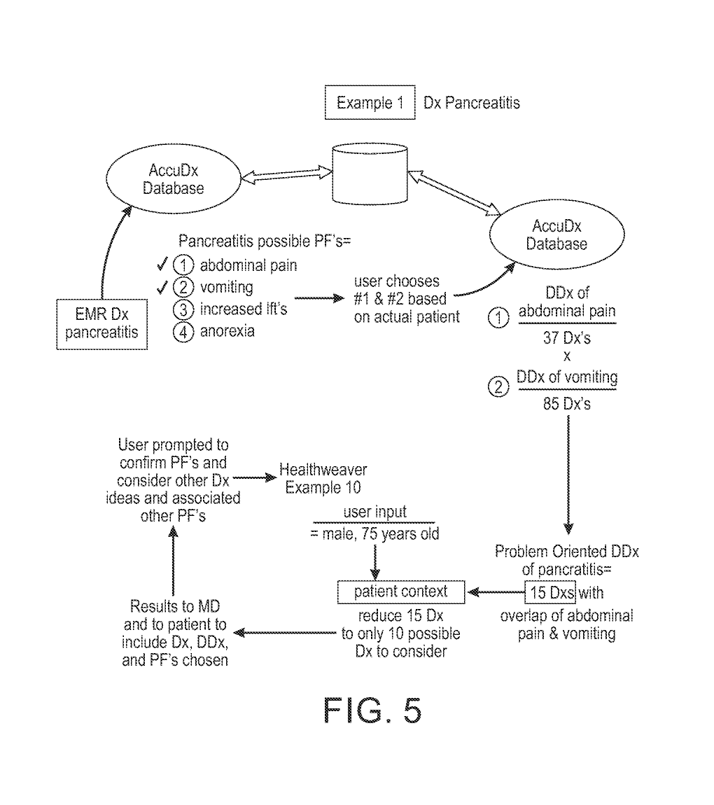

In this example, as generally represented by the flow diagram of FIG. 5, the physician would have either already made a presumptive Dx of pancreatitis or the Dx is already in the EMR problem list of a hospitalized patient. Using the example of a patient in the hospital having already been diagnosed incorrectly as having pancreatitis by the physician on the prior shift. The physician coming on in the next shift, by pursuing this type of DDx decision support, is presumed to have some doubt for the Dx. Perhaps some of the symptoms do not fit with pancreatitis or perhaps the patient does not have all of the symptoms patients with pancreatitis normally have. The entry points are also illustrated in FIG. 2. The Medweaver system, in its simplest manifestation, would reduce pancreatitis to the core PFs for that Dx. This list of core PFs would have been generated during the creation of the system based on expert opinion(s) and/or medical literature. During the use of Medweaver in this case, the core PFs would be extracted from the knowledge relationship database (e.g., AccuDx as illustrated in FIG. 5) and presented to the user. The Medweaver database would include all PF to Dx relationships that exist in nature and these relationships would be based on the medical literature and medical expertise. The database would be maintained and at least periodically updated by medical experts. The database would thus include all PFs associated with pancreatitis (e.g. abdominal pain, vomiting, anorexia, and increased LFTs) and also all possible Dxs associated with any individual PF (e.g. for abdominal pain, the DDx includes pancreatitis, gastritis, ectopic pregnancy, appendicitis, gastroenteritis, etc. . . . and for increased LFTs the DDx includes pancreatitis, viral hepatitis, alcoholic hepatitis, etc. and so on).

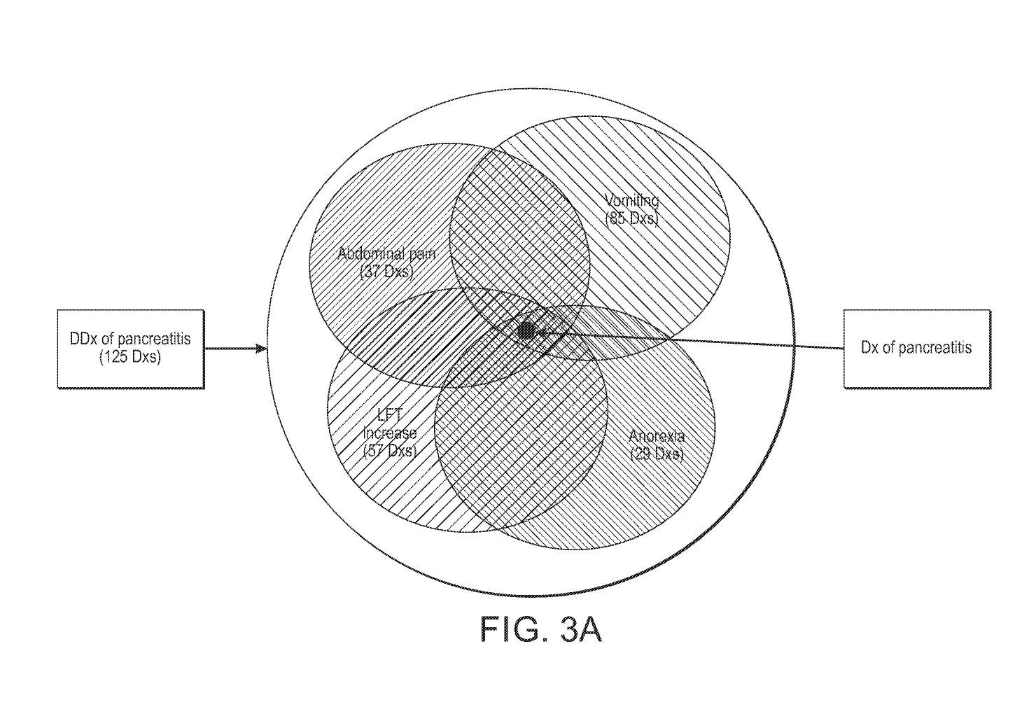

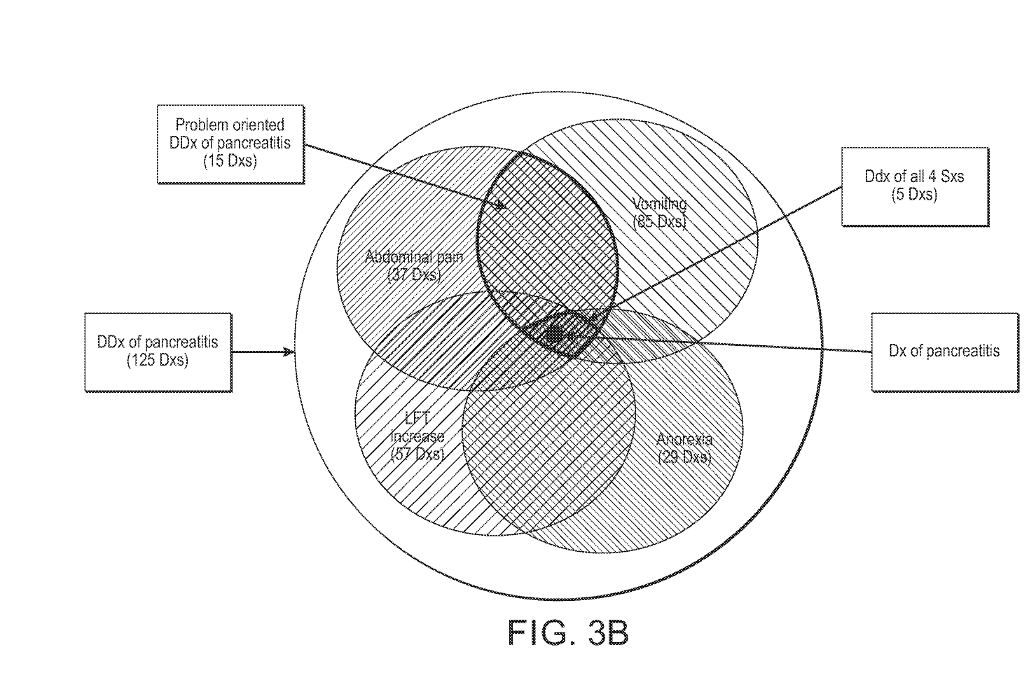

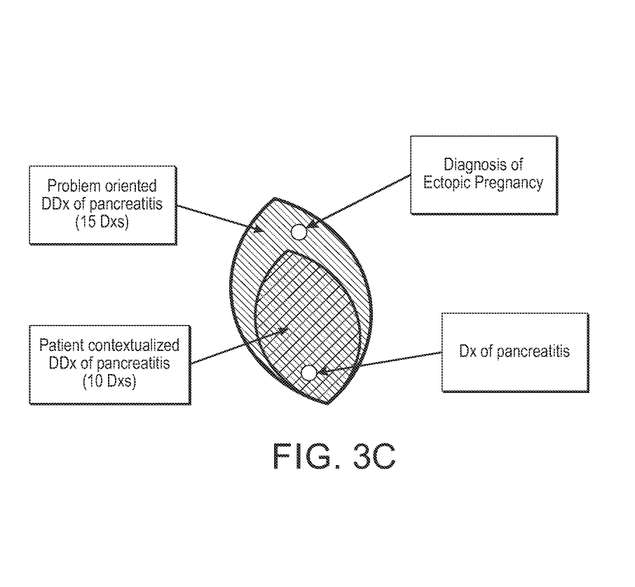

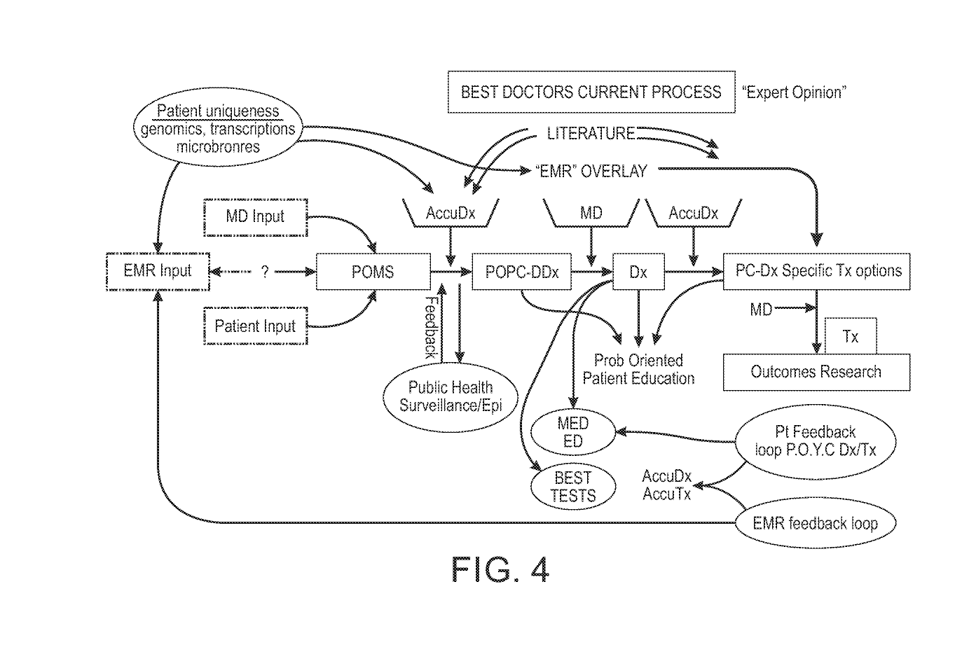

When a user queries the Dx of pancreatitis, the Medweaver UI would prompt the user to choose from all possible PFs known to be associated with pancreatitis. In this example, as more specifically illustrated in FIG. 3A, the user would see a list of four pancreatitis-associated PFs that includes vomiting, abdominal pain, elevated LFTs, and anorexia. The user would be required to choose which of the PFs are relevant to the patient (i.e. which of the 4 possible PFs does the patient actually have?). If the user chose abdominal pain and vomiting, as denoted by the check-marks (because this is what the patient is suffering from), the AccuDx component of Medweaver would combine the DDx for abdominal pain (hypothetically 37 Dxs—also see FIG. 3A) with the DDx for vomiting (hypothetically 85 Dxs—also see FIG. 3A) and the resulting DDx would reflect a DDx for pancreatitis (hypothetically 15 possibilities—see bottom right of FIG. 5 and FIG. 3B) that is only focused on the relevant PFs the patient actually has. In one manifestation of the systems and methods disclosed herein, the user would then be prompted to contextualize the DDx based on age, gender or other factors (immune status, etc.) as illustrated in FIG. 3C.

Medweaver would narrow the DDx list based on the structured knowledge database. In this example, the Medweaver database would have all Dx-context relationships structured so that any Dx would be known to be possible or impossible in any context. For example, although ectopic pregnancy is in the flat DDx for pancreatitis, if the patient was a male, ectopic pregnancy could not be a possible cause of vomiting or abdominal pain. The result is thus a Problem-Oriented, Patient Contextualized (POPC) DDx. Finally, the user would be allowed to refine the DDx by overlaying other specific symptoms or findings. In addition to the PF-Dx-Context structured data, the Medweaver database will also include structured knowledge around individual symptoms or findings at a much more granular level. For example, certain abdominal infections would be more common in a patient who traveled to Peru. If the finding of “travel to Peru” were entered, the DDx for pancreatitis could be cross-referenced to all Dxs more common after travel to Peru. It is important to distinguish this level of findings from PFs because the Medweaver systems and methods would not result in a meaningful return if the PF level of findings were not employed (see Example 4 below). Thus, in the example described above, the resulting DDx would be a “PF-based and patient contextualized DDx” for pancreatitis, as shown within region 310.

2) Search Presenting Problem—Abdominal Pain:

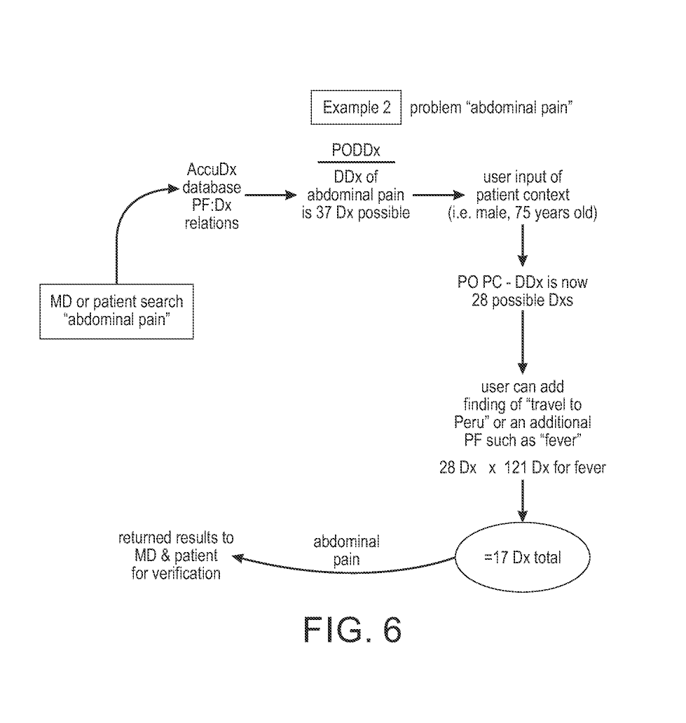

If the user of the Medweaver system begins with a more general search using only a problem without a specific Dx, as generally represented by the flow diagram of FIG. 6, the Medweaver system would search in the structured knowledge database of PF-Dx relationships for the closest related PF and search the knowledge management system for all of the Dxs that can present with abdominal pain and then prompt the user to contextualize the search (as described in Example 1 and as illustrated in the upper right of FIG. 6) to the specific patient and to overlay any relevant medical history or other symptoms not previously considered. The system essentially transforms any problem or finding search to core PF search to yield better results through a structured knowledge database and patient contextualization after the refined search.

3) Search Medication—Captopril:

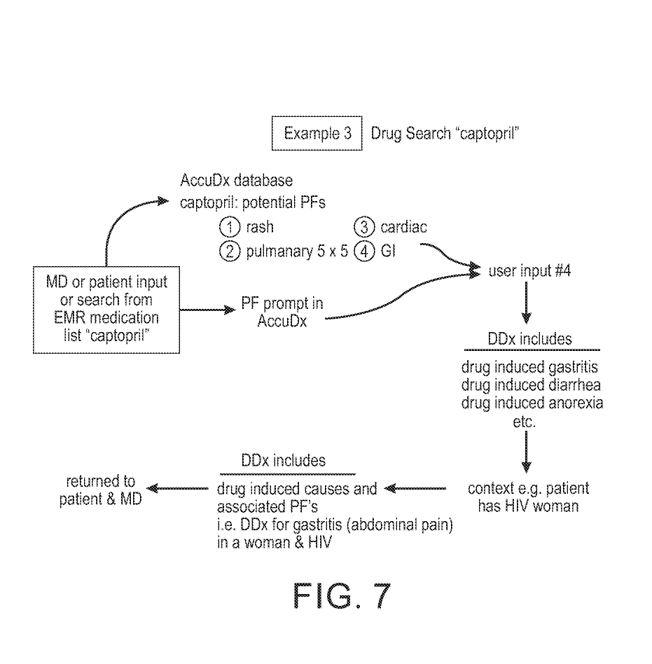

If a user was interested to know all of the reactions or diseases known to be affected by captopril, the search could begin either in the medication list in the EMR or by typing captopril into the search bar (see “MD Input” or “Patient Input”) in FIG. 2), as generally shown in the flow diagram of FIG. 7. The drug name would prompt a PF search but require the user to tell it which problem the patient was suffering from. This advance improves a drug reaction search to define it as a PF and then allows for contextualization to the specific patient. For example, some drugs may only have a specific reaction in women or immunosuppressed patients. The contextualization is illustrated in the lower right of FIG. 7, and results in the DDx as illustrated.

4) Search Medical History Finding—Peru:

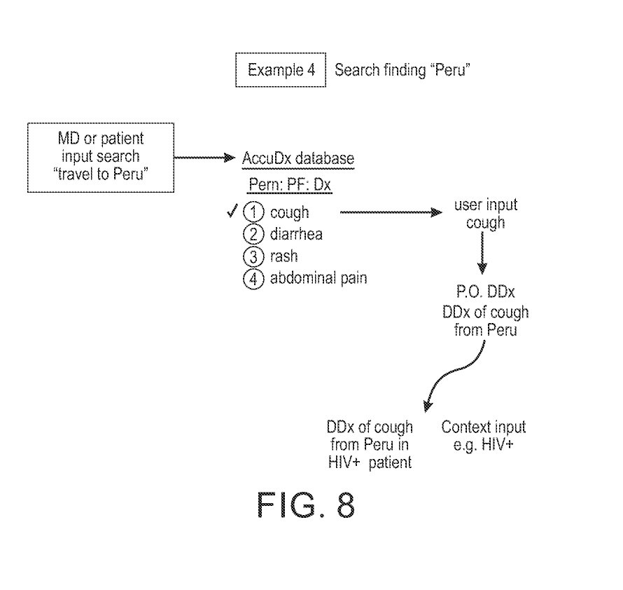

Referring to FIG. 8, for example, if a user was interested to know all of the infections or diseases known to be influenced by the geographic region of Peru (travel to or otherwise), the search could begin in the search bar (e.g., MD Input or Patient Input in FIG. 2). As with a drug exposure, the country search would prompt a PF search but require the user to tell it which type of problem or symptom (e.g. skin rash or cough or abdominal pain) the patient was suffering from. For example, the DDx for a patient who traveled to Peru with a cough is much different than the DDx of a patient who returned from Peru with a rash. This advance basically improves travel related search to define it as a PF area as well.

5) Reverse Automated Search into the EMR to Detect Underlying Disease—Untangler Detects Systemic Lupus Erythematosus:

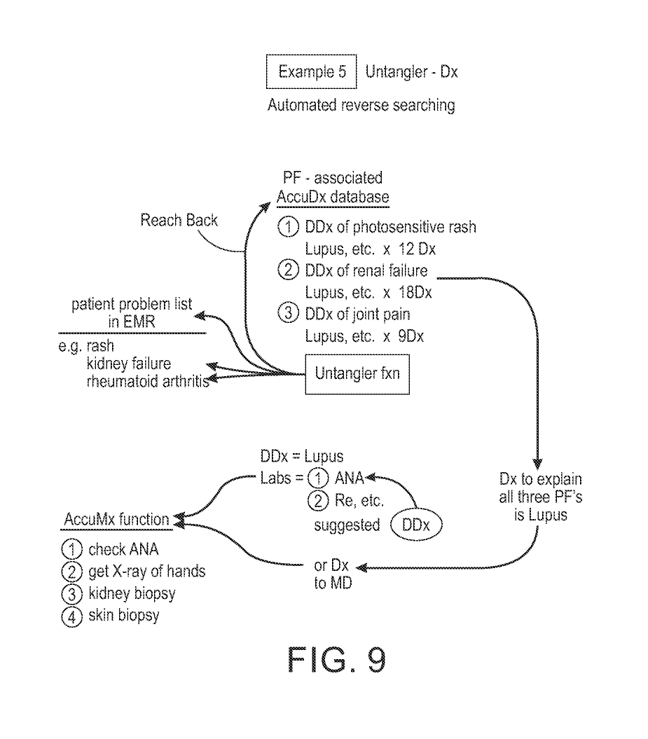

One function of Medweaver, called the Untangler (see e.g., FIG. 2 back arrow and FIG. 9) would perform automated “reach back” analysis of the EMR to determine if one or several of a patient's problems or symptoms could be better explained by an overarching or unrelated Dx. For example, if a patient has three items in the problem list—photosensitive dermatitis (rash), kidney failure, and rheumatoid arthritis (joint pain)—the Untangler function would reduce all items in the EMR problem list to core PFs and combine the search as all combinations and permutations to produce various types of DDx that could explain one or more Dxs or problems in the EMR problem list. In this case, the Untangler would reduce the skin rash, kidney failure, and joint pain to core PFs.

As in Example 1, the Medweaver database (AccuDx) will include the DDx for all the associated PFs determined to be relevant in this case (e.g. the DDx for a photosensitive rash includes medication induced rashes, Lupus, photoallergies, etc. and the DDx for renal failure includes diabetes, Lupus, etc. and so on). The Medweaver Untangler function would then automatically sort through all the DDx lists to see if there are any common causes of multiple PFs across the problem list. The Untangler would then suggest to the user that the unifying Dx of Lupus may better explain the constellation of independent problems listed. The user would then use the AccuMx function to consider the most appropriate work up of Lupus in this patient.

Additionally, these PF-based results could then be combined with other features in the EMR and compiled nationally to detect underlying disease trends and associations. An alternate example would be if the Untangler function was detecting increased incidence of the constellation of Dx-associated PFs of cough, rash, and diarrhea in patients known to have HIV (extracted from the EMR), it may suggest a previously undetected underlying infectious cause of these symptoms in this population or a novel type of drug reaction or the outgrowth of a drug resistant strain of HIV. Without the PF-based Untangler-type of analysis, this detection would not be possible.

6) Reverse Automated Search into the EMR to Detect Underlying Drug Reactions—Untangler Detects Doxycycline:

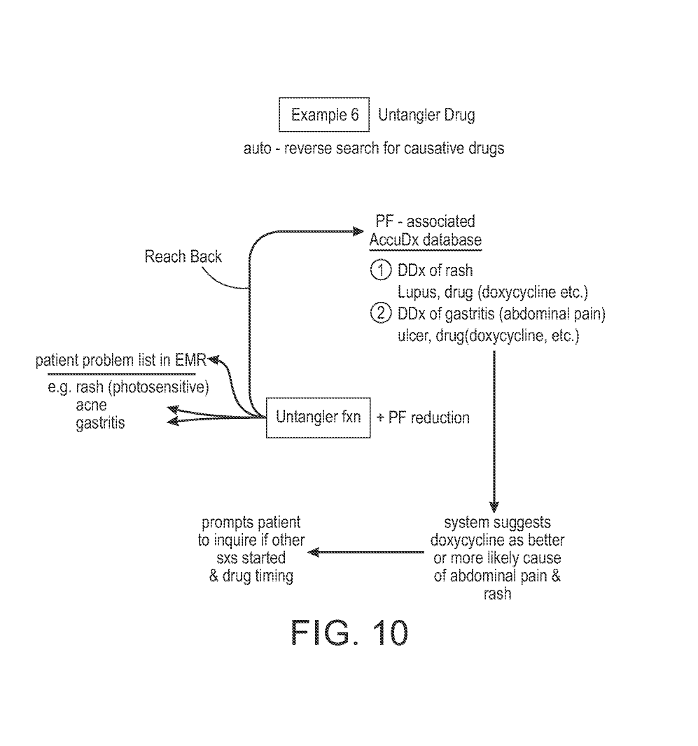

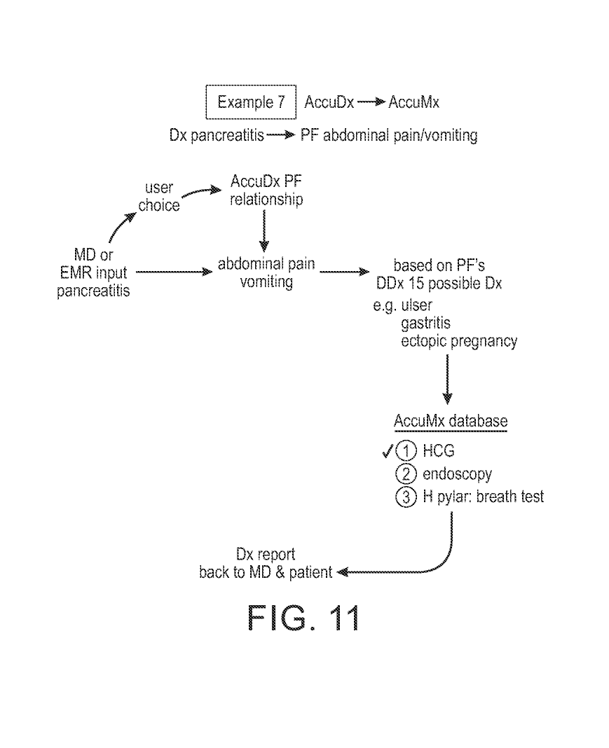

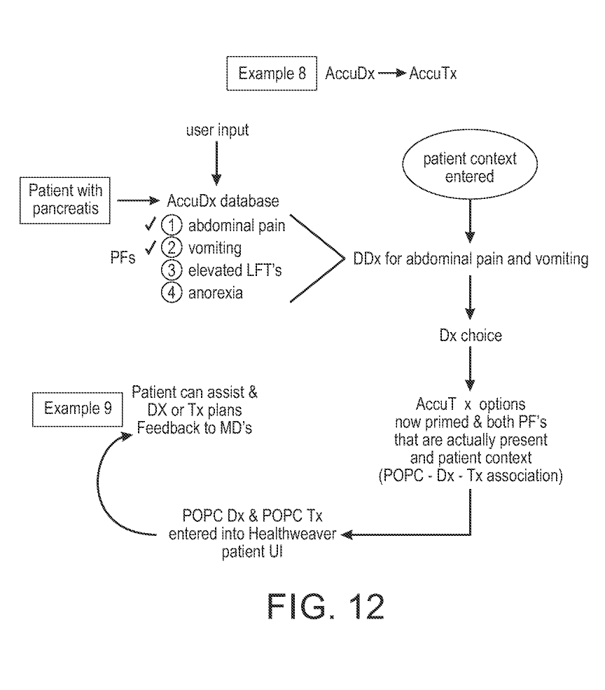

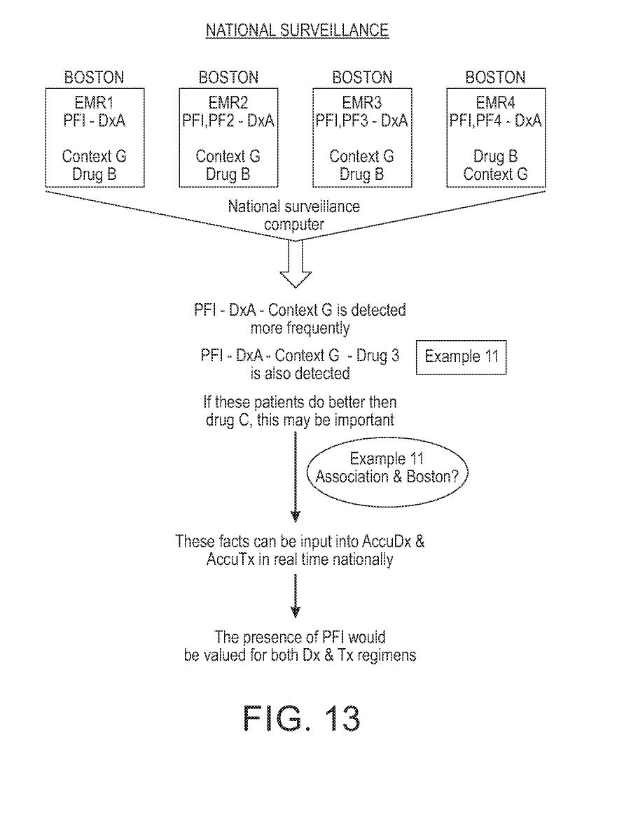

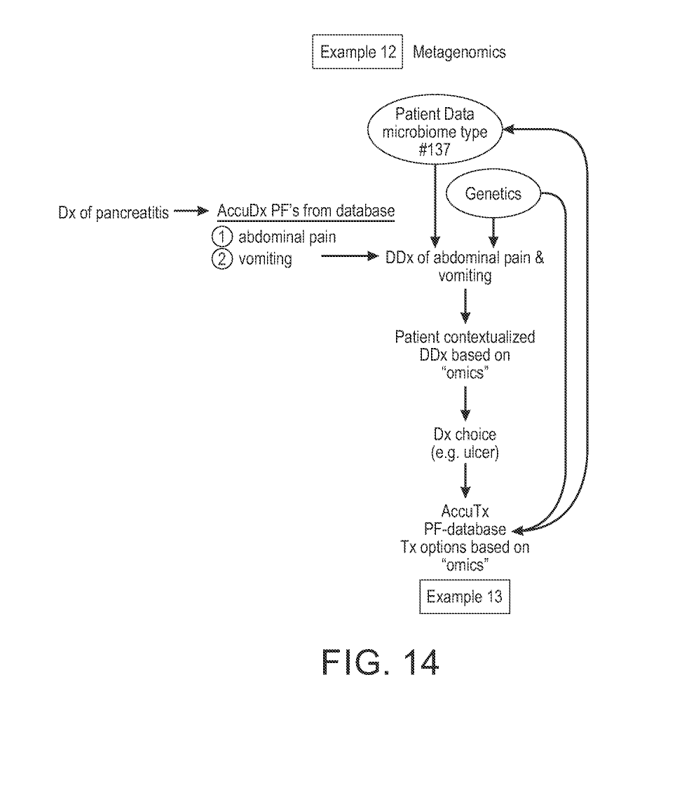

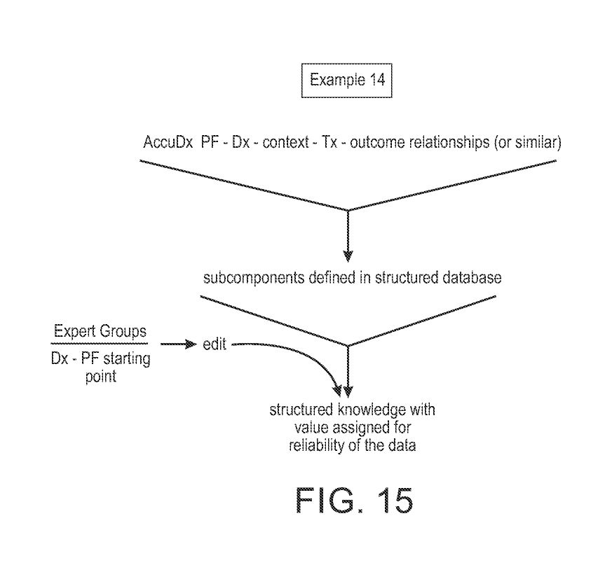

The Untangler function of Medweaver would perform automated analysis of the EMR, as generally represented by the flow diagram of FIG. 10, to determine if any of a patient's problems could be better explained by one of the drugs listed in the medication list. For example, if a patient has two items in the problem list—photosensitive dermatitis (rash), acne, and gastritis (abdominal pain), the Untangler would reduce these items in the EMR problem list to core PFs. Next the system would use the Medweaver structured knowledge database of PF-Dx and PF-drug relationships and then combine the search alone or as all combinations and permutations to produce various types of drug induced reactions that could explain one or more Dxs or problems in the EMR problem list. In this case, the Untangler would reduce the skin rash to its core PFs (e.g., photodistributed erythematous papules), and reduce gastritis to the PF of abdominal pain and query the medication list in the EMR. The system would then suggest to the user that the doxycycline (being used to treat acne here) is a common cause of both a photosensitive rash and gastritis. This might prevent an expensive work-up of either Lupus (expensive laboratory tests to work-up the cause of the rash) and prevent an endoscopy (dangerous and potentially unnecessary procedure if the symptoms resolve when the patient stops the offending drug).

Additionally, the data from this type of analysis could be combined with other items from the EMR and compiled nationally in real time to detect drug-associated problems that may otherwise go undetected. For example, this mechanism would be able to detect outbreaks like the epidemic of fungal meningitis associated with patients who received intrathecal steroids for back pain recently. In theory, patients with meningitis (or the associated PFs undiagnosed—headache or photophobia) would be compiled nationally and the Untangler system would detect on a national level the association with the drug they each received.

7) Using PF-Based Results to Improve Work-Up Plan—AccuDx Results Prime AccuMx System for Justified Testing:

The system would function as in Example 1. In patients with constellations of symptoms that prompt a specific diagnostic thought in the clinician's mind (i.e. pancreatitis), the Dx (or Dxs) would be reduced to the possible PFs by Medweaver. The system would then prompt the user to enter only the relevant PFs. These results would suggest a list of possible DDx. In this example, the POPC results would be fed into a management category matrix (FIG. 1B—Area 105, A, B) that could be based on the PFs and the Dx considerations to arrive at a more relevant and appropriate work-up and management plan in the absence of a firm Dx (FIG. 2).

8) Using PF-Based Results to Improve Treatment Plan—AccuDx Results Prime AccuTx System for Patient Contextualized and Optimized Therapies:

The system would again function as in Example 1. In patients with constellations of symptoms that prompt a specific diagnostic thought in the clinician's mind (i.e. pancreatitis), the Dx (or Dxs) would be reduced to the possible PFs by Medweaver. The system would then prompt the user to enter only the relevant PFs. These results would suggest a list of possible DDx. In this example, the individual problems that the patient is suffering from would be carried forward with the workflow in Medweaver so that the treatment plan can be appropriate for the patient at hand. After a Dx is chosen or a Mx plan is embarked on, therapies customized to the symptoms or severity of PFs associated with the Dx could be offered by the AccuTx system. In Example 1 above, since the patient does not have elevated LFT's, therapeutic measures (drugs or surgical) that consider the state of the liver could be considered in a different context. Also, if the patient were pregnant, the therapeutic options would be vastly different. The POPC Medweaver approach would allow both actual clinical manifestations and specific patient context during the assessment phase of care to influence the therapeutic guidelines.

9) the Use of Medweaver Results to Educate and Engage Patients—Medweaver Results Prompt Patient Education Through Healthweaver:

Consider a patient as in Example 1. If the patient was prompted to learn about both the diagnosis and the problems (PFs) that the clinician entered for their specific case, the Healthweaver patient interface could educate the patient about specific causes of pancreatitis with abdominal pain and vomiting. For example, the patient may not have offered to the clinician that they are taking an herbal supplement known to cause pancreatitis or that they are a closeted alcoholic, where alcohol is a known cause of pancreatitis. If the clinician did not know the patient drank high volumes of alcohol, the patient may have offered this in response to the Healthweaver prompt and this would generate a report to the clinician allowing the clinician to consider causes of pancreatitis that he learned about through patient education. This report would then re-engage the clinician. This same example could be used to illustrate a case where the patient could enter the scale of the pain or the frequency of the vomiting to provide feedback for the diagnostic process or therapeutic intervention.

This type of feedback loop can also power the outcomes research and improve the sensitivity of drug-efficacy measurements when compiled nationally in combination with patient context features. For example it may be determined that a drug to relieve pain is only effective in adults, but not in children in the context of pancreatitis without LFT increase (Example 1).

10) the Use of Medweaver to Improve Individual Patient Diagnosis.—Medweaver Results Prompt Patient Verification of Dx and PFs Through Healthweaver:

Consider a patient as in Example 1. If the patient was prompted to learn about both the diagnosis and the problems (PFs) that the clinician entered for their specific case, the Healthweaver patient interface could prompt the patient to consider other PFs the clinician may not have asked about. For example, as in Example 1, the patient could be prompted to consider other Dxs that share both abdominal pain and vomiting—suggestions may include or prioritize infectious causes associated with fever such as Salmonella. If the clinician did not know the patient had a fever two days prior, the patient might offer this in response to the Healthweaver prompt and this would generate a report to the clinician allowing the clinician to consider Dxs that include abdominal pain, vomiting, and fever. This report would then re-engage the clinician to interact with the patient.

11) Improvement of Public Health Surveillance Through the AccuDx Process and National Compiling—AccuDx PF-Based Results Prompt Public Health Surveillance Interface Query by Problem:

Because common diagnostic errors and decreased physician awareness about new diagnoses or epidemics often inhibit effective surveillance based on ICD-9, the AccuDx system could be leveraged to detect increases in “geography-PF” relationships or “patient context-PF” incidence. For example, multiple patients with low back pain from multiple diagnoses who also develop symptoms of meningitis, which would not normally be detected as a public health pattern until the Dxs are correctly made and reported. In this case, both the low back pain and the symptoms of meningitis could be detected using a PF based approach, but not traditional Dx-based analysis. See Example 6 as well.

Another example would include the increased detection of transplant patients with an increased incidence of an infectious and contagious disease that only presents as a cough and fever. Another example might include the detection of Kaposi's sarcoma as patients presenting with a particular rash in the San Francisco area during the beginning of the AIDS epidemic. This type of symptomology and problem-based approach is not typically coded in an EMR and is currently undetectable in the normal workflow and diagnostic process of clinicians on a national level. This type of epidemic might go undetected in larger populations if the patient context (immunosuppression) is not considered simultaneously with the analysis.

12) the Use of Metagenomics to Patient-Contextualized a DDx—AccuDx Results are Influenced by Geneweaver “Omics”:

Considering a patient with the symptoms in Example 1 with abdominal pain and vomiting, future research studies may determine that patients with a known mibrobiomic commensal population in their gut are more prone to a specific infection with pathogenic bacteria or that patients with a particular genetic mutation or variant are susceptible to a particular intestinal infection. The Medweaver database could include patient-contextualization features (like gender in Example 1) that reprioritize the DDx. Thus, in the microbiome profile of a patient is known, the PF-based AccuDx DDx could be re-prioritized based on the PFs entered through the pancreatitis DDx process and displayed in the context of a specific microbiome profile.

13) the Use of Metagenomics to Dx Specific Patient-Contextualized Tx—AccuTx Results are Influenced by Geneweaver “Omics”:

Considering a patient with the symptoms in Example 1 with abdominal pain and vomiting, a diagnosis of gastritis could be made. It may be determined by future research studies that patients with a known mibrobiomic commensal population profile in their intestines or patients with a particular genetic mutation or variant are more effectively treated with a particular class of anti-inflammatory drugs. Thus, the AccuTx results would be contextualized to that metagenetic background of patients. Moreover, the AccuDx-derived PFs could be carried forward into the AccuTx process and the AccuTx results would then be re-prioritized based on the PFs entered through the pancreatitis DDx process in the context of the known genomics or microbiomics profile-Tx relationship in the Medweaver database. A related example of how this is effective today (but not based on PF analysis) is the use of certain cardiovascular drugs or procedures in certain ethnic backgrounds based on known epidemiological data.

14) Enhancing an Existing Structured Knowledge Database Through Wiki-Like Editorial Effects and Crowd-Sourcing of Expert Knowledge—Medweaver Knowledge Database is Enhanced Through Expert Wiki Contributions, Diagnostic Error Case Analysis, and Actual Case Data:

For the example of meningitis cited at the end of Example 6, it may become clear that patients in this group with a photophobia component (PF) respond best to a particular class of antifungal agents delivered intrathecally. Individual physicians could, through a wiki-like portal, enter this information on an “expert-level” codified Dx-PF-Tx-outcome relational database in the Medweaver database. This real-time knowledge could be accumulated, analyzed, validated, and disseminated to the AccuTx component of Medweaver in real time to impact the care of existing patients who make up only a subset of those that were affected with meningitis. Additionally, thorough PF-based analysis of existing cases of diagnostic error or failed therapeutic regimens could be input into the Medweaver system in a systematic way to avoid similar errors in the future. For example, in the case of diagnostic errors, all mis-diagnoses of appendicitis that were treated with surgery could be analyzed by the PFs of each case. All cases would presumably have abdominal pain as one PF, but a subset of cases that were misdiagnosed may also have elevated LFTs and this meta-analysis of the PFs associated with Dx error cases could be input and analyzed to determine that these cases were more likely to have a true diagnosis of viral hepatitis so that this specific Dx error pathway could be avoided in the future and the correct Tx regimen implemented based on PFs in the context of a presumed Dx. In the example of failed therapeutic regimens, the Dx-PF-failed therapy relationships and data could be compiled in the Medweaver database nationally and this data could be used to power the AccuTx engine moving forward.

It should be understood that various changes and modifications to the embodiments described herein will be apparent to those skilled in the art. Such changes and modifications can be made without departing from the spirit and scope of the present disclosure and without diminishing its intended advantages. It is therefore anticipated that all such changes and modifications be covered by the instant application.

What is claimed is:

1. A method, operating in accordance with a program on a computer, to improve medical diagnostic accuracy, comprising:
using the computer, reducing a medical search to a plurality of fundamental problems called Principle Findules, and compiling at least one associated database with data for the Principle Findules; and
building differential diagnoses from Principle Findules based upon patient information.

2. The method according to claim A1, wherein the patient information includes information selected from the group consisting of: presumptive diagnoses, diagnoses already in a patient's problem list, undiagnosed problems, medications, genetic code, symptoms, lab values, and individual findings.

3. The method according to claim 2, wherein any diagnoses in a problem list of an electronic medical record is reduced to at least one Principle Findule based on a relational knowledge structured database; and
at least one relevant Principle Findule is presented to the user.

4. The method according to claim 3, further including at least one diagnosis-specific Principle Findule being chosen by the user to generate a differential diagnosis based on the user's choices and at least one diagnosis from the electronic medical record.

5. The method according to claim 1, further comprising contextualizing the differential diagnosis based upon at least one patient factor, present in a knowledge management system, selected from the group consisting of: age, immune status, race, epidemiological factors, geography, and metagenomic data.

6. The method according to claim 1, further comprising overlaying an item from the group consisting of specific findings, symptoms, elements of the medical history, and other medical information present in the knowledge management system. (AccuDx).

7. The method according to claim 1, further comprising:
searching for drug reactions from at least one medication listed in a patient electronic medical record; and
prompting the user to reduce the search to Principle Findules, problem types, or symptom types that could be related to drug-induced diagnoses.

8. The method according to claim 1, further comprising:
beginning a differential diagnosis search based on granular medical findings, including searching across the text of the knowledge management system and comprising a branch of a findings tree that is at a level of the Principle Findules.

9. The method according to claim 8, wherein the differential diagnosis is further refined based on the actual finding.

10. The method according to claim 1, wherein multiple diagnoses are obtained from the problem list in an electronic medical record, the diagnoses are reduce to Principle Findules, and then analyzed to determine if there are underlying Principle Findules consistent across multiple diagnoses that would be better defined with a different unifying diagnosis.

11. The method according to claim 10, wherein results are combined across a geographic region to detect underlying disease trends based on Principle Findule reduction and causative associations therein.

12. The method according to claim 1, wherein multiple diagnoses from the problem list in an electronic medical record are utilized and reduced to Principle Findules to determine if there is at least one underlying Principle Findule consistent across multiple diagnoses that may be caused by a drug reaction or drugs indicated in the medication list in the electronic medical record.

13. The method according to claim 12, wherein results are combined across a geographic region to detect underlying drug-disease associations based on Principle Findule reductions and association with drugs in the medication lists of the electronic medical record.

14. The method according to claim 13, wherein drug-associated epidemics of diagnoses or Principle Findules are detected based on statistical analyses.

15. The method according to claim 1, further comprising generating a management plan based on the Principle Findule-based results.

16. The method according to claim 15, wherein the method includes patient-contextualization and refinement of therapies based on metagenomic data.

17. The method according to claim 1, further comprising determining an effective treatment approach for a given diagnosis based on the Principle Findule-based results, including patient-contextualization and refinement of the work-up based on metagenomic data.

18. The method according to claim 1, further comprising, prompting the patient to provide outcome data through a user interface, including scaling at least one Principle Findule associated with a diagnosis to provide an assessment of outcomes based on symptoms rather than binary existence of the problem in general.

19. The method according to claim 4, further comprising a patient education operation prompting the patient to verify the Principle Findules.

20. The method according to claim 19, further including suggesting alternative diagnoses for the patient and clinician to consider.

21. The method according to claim 18, further comprising incorporating the data provided by populations of patients to determine the effectiveness of specific drugs in the context of associated Principle Findules and patient-graded severity of Principle Findules.

22. The method according to claim 1, further comprising employing an editorial process, compiling both expert knowledge and actual individual case data, to inform the database in a Principle Findule based relationship manner, wherein said process also adds statistical and importance factors to the database relationships.

23. A system to improve medical diagnostic accuracy, comprising:
using a computer operating in accordance with a program stored on computer readable media, to reduce diagnostic concepts in an EMR or any form of medical search to a plurality of fundamental problems called Principle Findules;
in response to a user input, said computer compiling at least one associated database with data for the relevant Principle Findules, said database stored in a computer readable media; and
building differential diagnoses from Principle Findules based upon patient information.

24. A system to improve surveillance and detection of disease trends comprising:
using a computer, operating in accordance with a program stored on computer readable media, to reduce diagnostic concepts in an electronic medical record to a plurality of fundamental problems called Principle Findules;
in response to a user input, said computer compiling at least one associated database with data for the relevant Principle Findules, said database stored in a computer readable media;
building differential diagnoses from Principle Findules based upon patient information; and
extracting data and compiling associations on at least a regional level.
